(19) United States
(12) Patent Application Publication
(10) Pub. No.: US 2026/0295861 A1
(43) Pub. Date: Oct. 1, 2026

(54) OPERATION ROBOT SYSTEM AND CONTROL METHOD THEREFOR

(71) Applicant: DAIFUKU CO., LTD., Osaka-shi (JP)

(72) Inventors: Takahiro YOSHIDA, Tokyo (JP); Tsutomu Ishihara, Tokyo (JP); Hiroyuki Ebina, Tokyo (JP); Kozo Hasegawa, Tokyo (JP)

(73) Assignee: DAIFUKU CO., LTD., Osaka-shi (JP)

(21) Appl. No.: 19/536,535

(22) Filed: Feb. 11, 2026

(30) Foreign Application Priority Data
Mar. 31, 2025 (JP) 2025-058881

(51) Int. Cl. B25J 13/08; B25J 9/16

(52) U.S. Cl. CPC B25J 13/088; B25J 9/163; B25J 9/1633; B25J 9/1676; B25J 13/085

(57) ABSTRACT

In order to be unlikely to be damaged even when a positional shift occurs with respect to a target article in an assembly line for the target article, an operation robot includes: a hand section configured to be connected to a target article; an arm section configured to control a position of the hand section; a floating mechanism disposed between the hand section and the arm section and configured to permit a change of a relative position of the hand section with respect to the arm section; a regulation mechanism configured to carry out regulation of the change of the relative position by the floating mechanism; and a regulation mechanism control section configured to, in accordance with a conveyance speed of the target article and whether the target article and the hand section are connected, control whether or not the regulation by the regulation mechanism is carried out.

This Nonprovisional application claims priority under 35 U.S.C. § 119 on Patent Application No. 2025-058881 filed in Japan on Mar. 31, 2025, the entire contents of which are hereby incorporated by reference.

### TECHNICAL FIELD

The present disclosure relates to an operation robot system including an operation robot configured to carry out an operation in, for example, an assembly line.

### BACKGROUND ART

In, for example, assembly lines for automobiles, a vehicle body under assembly is assembled by an assembly robot while being conveyed by a conveyor machine. At this time, the assembly robot carries out assembly with a part thereof docked with a part of the vehicle body while moving at the same speed as the conveyance speed of the vehicle body.

For example, Patent Literature 1 discloses a device used in a bolt/nut supply device for an automobile assembly line or the like, a device including a floating section that permits movement of a supply shaft section in horizontal and vertical directions.

### CITATION LIST

### Patent Literature

[Patent Literature 1]
Japanese Patent Application Publication Tokukai No. 2002-254258

### SUMMARY OF INVENTION

### Technical Problem

As described above, during assembly, part of a vehicle body and part of an assembly robot are docked. In a case where conveyance of the vehicle body and movement of the assembly robot stop for any reason during the docking, a shift occurs in a relative position between the vehicle body and the assembly robot since the vehicle body and the assembly robot are different in the distance until stopping (braking distance). This causes an unexpected load to be applied to the vehicle body or the assembly robot, which may cause damage.

Patent Literature 1 is silent about damage caused by the positional shift of a vehicle body with an assembly robot.

The present invention has been made in light of the foregoing problem, and it is an object thereof to achieve a system including an assembly robot which makes it unlikely for a vehicle body or the assembly robot to be damaged even when a positional shift occurs between the vehicle body and the assembly robot.

### Solution to Problem

In order to attain the object, an operation robot system in accordance with an aspect of the present disclosure includes: an operation robot configured to carry out an operation on a target article, which is a target of the operation, while moving at a speed identical to a speed of conveyance of the target article; a hand section configured to be connected to the target article in the operation; an arm section configured to control a position of the hand section so as to connect the hand section and the target article; a floating mechanism disposed between the hand section and the arm section, connecting the hand section and the arm section, and configured to permit a change of a relative position of the hand section with respect to the arm section; a regulation mechanism configured to carry out regulation of the change of the relative position by the floating mechanism; and a regulation mechanism control section configured to, in accordance with the speed of the conveyance and whether the target article and the hand section are connected, control whether or not the regulation by the regulation mechanism is carried out.

In order to attain the object, a method for controlling an operation robot system in accordance with an aspect of the present disclosure is an operation robot system controlling method including controlling, for an operation robot including a floating mechanism, regulation of a change of a relative position by the floating mechanism, the operation robot system including the operation robot configured to carry out an operation with a hand section thereof connected to a target article, which is a target of the operation, while moving at a speed identical to a speed of conveyance of the target article, the operation robot including a regulation mechanism configured to carry out regulation of the change of the relative position by the floating mechanism and a regulation mechanism control section configured to control the regulation by the regulation mechanism, the method including: a detection step of using the regulation mechanism control section to detect an abnormality in the conveyance of the target article; and a release step of using the regulation mechanism control section to release the regulation by the regulation mechanism when the abnormality is detected.

### Advantageous Effects of Invention

According to an aspect of the present disclosure, it is possible to prevent damage to a target article or an operation robot.

### BRIEF DESCRIPTION OF DRAWINGS

FIG. 1 is a view illustrating an overview of an operation robot system in accordance with Embodiment 1 of the present disclosure.

FIG. 2 is a view illustrating examples of a hand section, a floating mechanism, and a regulation mechanism in an operation robot.

FIG. 3 is a view simply illustrating a floating mechanism as viewed from the side.

FIG. 4 is a cross-sectional view illustrating a cross-section of a pin part which is along its axial direction.

FIG. 5 is a cross-sectional view illustrating an example of a hole provided in a first component.

FIG. 6 is a view illustrating an example control over regulation of a regulation mechanism by a regulation mechanism control section.

FIG. 7 is a flowchart illustrating a flow of a regulation process by a regulation mechanism control section.

FIG. 8 is a view illustrating an example of a hand section in a case where a target article is an automobile.

FIG. 9 is a view illustrating another example of a pin part.

### DESCRIPTION OF EMBODIMENTS

### Embodiment 1

The following description will discuss an embodiment of the present disclosure in detail. An operation robot system 10 in accordance with the present embodiment is configured to assemble a manufactured article which is an assembly target with use of an operation robot 1 in an assembly line for automobiles or the like. In the present embodiment, the manufacture article which is an assembly target is referred to as “target article 100”.

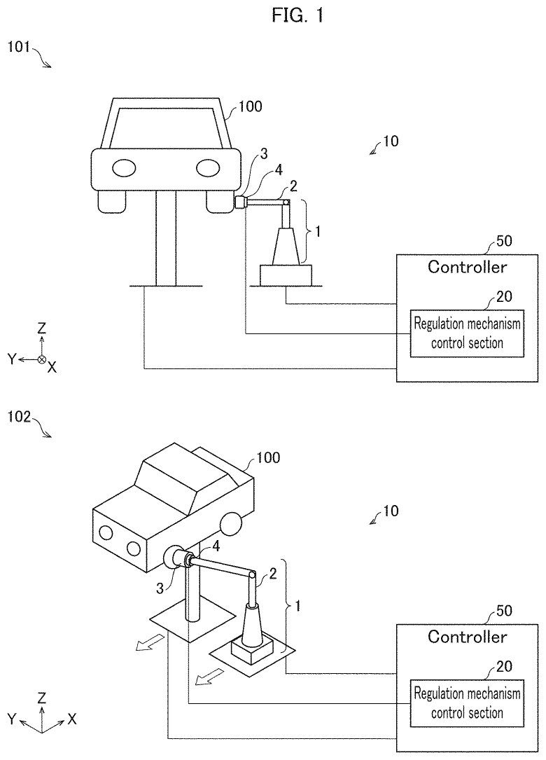

FIG. 1 illustrates a state in which an operation robot 1 is carrying out an operation on the target article 100 in an assembly line. In FIG. 1, as an example, the target article 100 is an automobile, and a state is illustrated in which the operation robot 1 is carrying out an operation on an assembly part of the automobile as the target article 100. Reference numeral 101 of FIG. 1 indicates a view illustrating the state of the automobile, which is the target article 100, as viewed from the front, and reference numeral 102 of FIG. 1 indicates a view illustrating the state of the target article 100 as viewed from obliquely above. As indicated by reference numeral 102 of FIG. 1, the target article 100 and the operation robot 1 travel in a −X direction independently of each other. The operation robot 1 carries out an operation while travelling at the same conveyance speed as that of the target article 100.

A separate controller 50 configured to carry out control over the entire assembly line is provided, and the controller 50 includes a regulation mechanism control section 20. The regulation mechanism control section 20 controls whether or not a regulation mechanism 110 described later carries out regulation. Note that the regulation mechanism control section 20 may be a mechanism included in the operation robot 1.

The operation robot 1 includes an arm section 2, a hand section 3, and a floating mechanism 4.

The hand section 3 is a section configured to be connected to the target article 100 in the operation. The arm section 2 is a section configured to control a position of the hand section 3 so as to connect the hand section 3 and the target article 100.

The floating mechanism 4 is disposed between the hand section 3 and the arm section 2 and connects the hand section 3 and the arm section 2. Further, the floating mechanism 4 permits a change of a relative position of the hand section 3 with respect to the arm section 2. The floating mechanism 4 will be described later in detail.

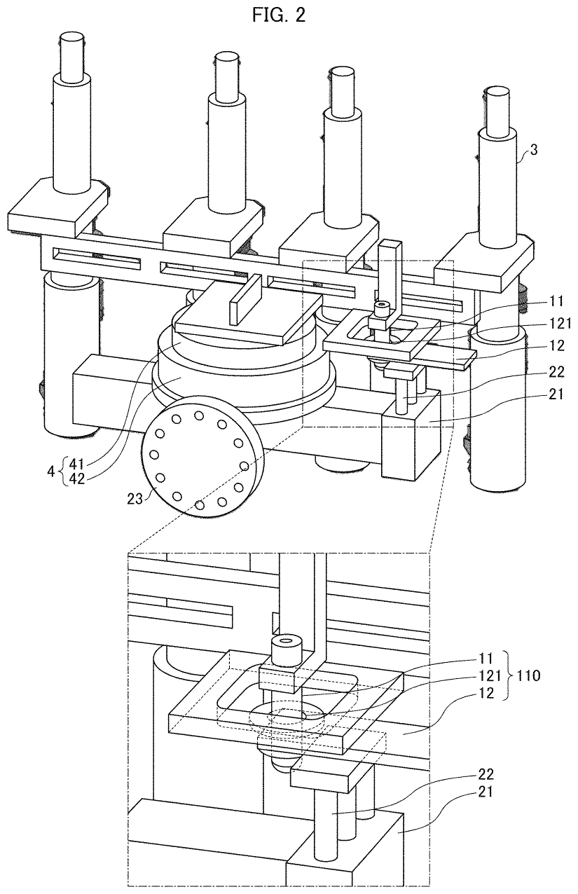

FIG. 2 illustrates examples of the hand section 3, the floating mechanism 4, and the regulation mechanism 110. The hand section 3 may be, for example, a nut runner that tightens bolts and the like to the target article 100. In the example illustrated in FIG. 2, the floating mechanism 4 has, for example, a columnar shape, and includes a first part 41 and a second part 42 that are different in diameter. The first part 41 and the second part 42 are movable in a direction parallel to a contact surface therebetween, so that the floating mechanism 4 exerts a floating function. That is, the floating mechanism 4 is configured to permit a change of a relative position between a part connected to the first part 41 and a part connected to the second part 42 through movement of the second part 42 with respect to the first part 41.

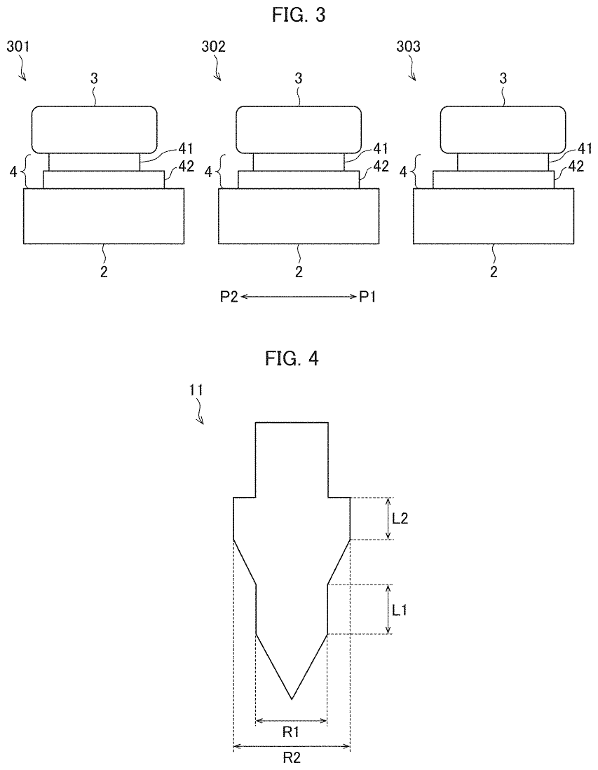

With reference to FIG. 3, the following will provide a specific description. FIG. 3 is a view simply illustrating the floating mechanism 4 as viewed from the side. A state is illustrated in which the hand section 3 is connected to the first part 41 of the floating mechanism 4, and the arm section 2 is connected to the second part 42. Reference numeral 302 of FIG. 3 indicates a state in which the first part 41 is located at the center with respect to the second part 42, reference numeral 301 indicates a state in which the first part 41 is shifted in a P2 direction with respect to the second part 42, and reference numeral 303 indicates a state in which the first part 41 is shifted in a P1 direction with respect to the second part 42. As such, through the shift of the first part 41 with respect to the second part 42, a change of a relative position of the hand section 3 with respect to the arm section 2 is permitted.

Returning to FIG. 2, the description continues. The first part 41 of the floating mechanism 4 is connected to the hand section 3 and is connected to a pin part 11. Accordingly, the hand section 3 and the pin part 11 move integrally with the first part 41. Further, the second part 42 of the floating mechanism 4 is connected to the arm section 2 via a connection section 23, and thus the second part 42 and the arm section 2 move integrally. Further, to the second part 42, a drive section 21 configured to drive a cylinder 22 is connected. The cylinder 22 is connected to a first component 12 provided with a hole 121. Driving of the cylinder 22 causes the first component 12 to move toward the pin part 11, and the pin part 11 is accordingly inserted into the hole 121 of the first component 12. Insertion of the pin part 11 into the hole 121 of the first component 12 regulates the shift of the first part 41 with respect to the second part 42 illustrated in FIG. 3. That is, the floating function of the floating mechanism 4 is regulated. Thus, it can be said that the pin part 11 and the first component 12 form the regulation mechanism 110.

### Detail of Pin Part 11

Next, with reference to FIG. 4, the following description will describe the detail of the pin part 11. FIG. 4 is a cross-sectional view illustrating a cross-section of the pin part 11 which is along its axial direction. The pin part 11 is a pin including an L1 part in which a diameter of the cross-section thereof perpendicular to an axial direction is R1, and an L2 part in which a diameter of the cross-section thereof is R2 (>R1). That is, the pin part 11 has a shape that varies in thickness in an axial direction. Although details will be described later, by including the L1 part and the L2 part that are different in diameter of the cross-section, it is possible to adjust a degree of regulation. In other words, since the pin part 11 has a shape that varies in thickness in an axial direction, it is possible to adjust an amount of a change to be regulated, in accordance with a degree of the insertion into the hole.

Note that the shape of the pin part 11 is not limited to the one in which the cross-section perpendicular to the axial direction is a circle. For example, the pin part 11 may have a shape in which the cross-section thereof perpendicular to the axial direction has an elliptical or polygonal shape. Further, in a portion of the pin part 11, the cross-section thereof perpendicular to the axial direction may have an elliptical or polygonal shape.

### Example of Hole 121

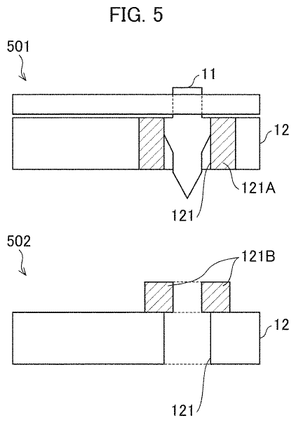

FIG. 5 is a cross-sectional view illustrating an example of the hole 121 provided in the first component 12. Reference numeral 501 of FIG. 5 indicates an example in which a bush 121A (second component) is disposed on a side surface of the hole 121. Further, reference numeral 502 of FIG. 5 indicates an example in which a cam follower 121B (second component) is disposed on an upper surface and a side surface of the hole 121. As indicated by reference numerals 501 and 502 of FIG. 5, in a case where the bush 121A or the cam follower 121B is disposed in the hole 121, contact between an outer surface of the pin part 11 and an inner surface of the bush 121A or cam follower 121B enables regulation by the regulation mechanism 110 to be carried out.

Both the bush 121A and the cam follower 121B are of a material or shape that has less friction than that of the first component 12. This facilitates insertion of the pin part 11 into the hole 121 and withdrawal of the pin part 11 from the hole 121, and makes it possible to prevent damage to the first component 12 itself. More specifically, by disposing the bush 121A on the side surface of the hole 121 or disposing the cam follower 121B on an upper part of the side surface of the hole 121, it is possible to reduce friction due to contact with the pin part 11 and absorb vibration and impact, and it is possible to delay deterioration of the pin part 11 and the hole 121. Further, even in a case where repair is needed due to deterioration or the like, it is merely necessary to replace the bush 121A or the cam follower 121B, and maintenance can be carried out easily and simply.

### Detail of Control by Regulation Mechanism Control Section 20

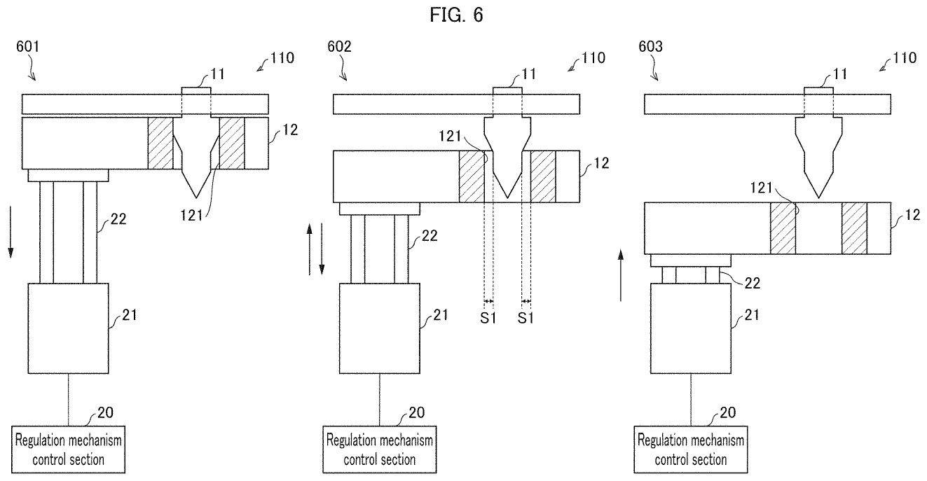

Next, with reference to FIG. 6, the following will describe control over regulation of the regulation mechanism 110 by the regulation mechanism control section 20. As illustrated in FIG. 6, the regulation mechanism control section 20 controls the drive section 21 to adjust the length of the cylinder 22. The cylinder 22 is connected to the first component 12, and the length of the cylinder 22 determines which of three states is adopted: a first state (first regulation), a second state (second regulation), and a third state (third regulation). The first state refers to a state in which the pin part 11 is fully inserted into the hole 121 of the first component 12. The second state refers to a state in which part of the pin part 11 is inserted into the hole 121. The third state refers to a state in which the pin part 11 is fully withdrawn from the hole 121.

The regulation mechanism control section 20 controls the drive section 21 to control the regulation mechanism 110 so that the regulation mechanism 110 transitions to any one of the first state, the second state, and the third state.

Reference numeral 601 of FIG. 6 indicates the first state. In the first state, the outer periphery of the pin part 11 comes into contact with the inner periphery of the hole 121, and regulation by the regulation mechanism 110 is being carried out. That is, this is a state in which the function of the floating mechanism 4 is fully regulated. Reference numeral 602 of FIG. 6 indicates the second state. In the second state, there is a space S1 between the outer periphery of the pin part 11 and the inner periphery of the hole 121, and regulation by the regulation mechanism 110 is partially carried out. That is, this is a state in which the function of the floating mechanism 4 can be carried out by a distance corresponding to the space S1. Reference numeral 603 of FIG. 6 indicates the third state. In the third state, since the pin part 11 is fully withdrawn from the hole 121, this is a state in which the function of the floating mechanism 4 is fully exerted.

The regulation mechanism control section 20 may be configured to carry out the above-described control over the regulation in response to detection of an abnormality. For example, the regulation mechanism control section 20 may, when receiving a notification indicating an abnormality has occurred from a detection section (not illustrated) that detects occurrence of an abnormality in an assembly line, cause the regulation mechanism 110 to transition to the second state or the third state.

As such, the regulation mechanism 110 regulates an amount of a change of a relative position in the floating mechanism 4 in a plurality of stages. Further, the regulation mechanism control section 20 is configured to control the plurality of stages for the regulation by the regulation mechanism 110 in accordance with the conveyance speed and whether the target article 100 and the hand section 3 are connected. This makes it possible to vary an amount of a change permitted by the floating mechanism 4, in accordance with the stage of the regulation by the regulation mechanism 110, and it is possible to carry out regulation by the regulation mechanism 110 in accordance with a degree of the positional shift between the target article 100 and the operation robot 1.

Note that although the present embodiment has described a configuration in which control is carried out to transition to any one of the three states: the first state, the second state, and the third state, that is, a configuration in which the control is carried out in three stages, the invention in accordance with the present disclosure is not limited to this. A configuration may be employed in which control is carried out to transition to one of two states: a restricting state and a non-restricting state, or a configuration may be employed which includes four or more states and in which control is carried out to transition to any one of these states.

Although the foregoing has described a configuration in which the first component 12 is driven to insert the pin part 11 into the hole 121 and withdraw the pin part 11 from the hole 121, the invention in accordance with the present disclosure is not limited to this. A configuration may be employed in which the pin part 11 is driven, or a configuration may be employed in which both the pin part 11 and the first component 12 are driven. In this case, it is sufficient that the drive section 21 carries out at least one of an insertion operation of the pin part 11 into the hole 121 and a withdrawal operation of the pin part 11 from the hole 121. This enables insertion of the pin part 11 into the hole 121 and withdrawal of the pin part 11 from the hole 121 to be carried out by driving at least one of the pin part 11 and the first component 12.

As such, the operation robot system 10 in accordance with the present disclosure includes the operation robot 1 that carries out an operation on the target article 100, which is a target of the operation, while moving at the same speed as the conveyance speed of the target article 100. The operation robot 1 includes the arm section 2, the hand section 3, the floating mechanism 4, and the regulation mechanism 110. The hand section 3 is a section configured to be connected to the target article 100 in the operation. The arm section 2 is configured to control a position of the hand section 3 so as to connect the hand section 3 and the target article 100. The floating mechanism 4 is disposed between the hand section 3 and the arm section 2, connects the hand section 3 and the arm section 2, and is configured to permit a change of a relative position of the hand section 3 with respect to the arm section 2. The regulation mechanism 110 regulates a change of the relative position by the floating mechanism 4. Further, the operation robot system 10 includes the regulation mechanism control section 20, and the regulation mechanism control section 20 controls, in accordance with the conveyance speed and whether the target article 100 and the hand section 3 are connected, whether or not the regulation by the regulation mechanism 110 is carried out.

Thus, a change of a relative position of the hand section 3 connecting the target article 100 and the operation robot 1 with respect to the arm section 2 is permitted by the floating mechanism 4 in accordance with whether the regulation by the regulation mechanism 110 is being carried out. Further, whether the regulation mechanism 110 carries out regulation is controlled in accordance with the conveyance speed and whether the hand section 3 and the target article 100 are connected. Thus, in a case where the target article 100 stops while connected to the hand section 3 of the operation robot 1, a shift of a relative position between the target article 100 and the hand section 3 is permitted by releasing the regulation by the regulation mechanism 110. This makes it possible to prevent damage to the target article 100 or the operation robot 1.

### Flow of Process

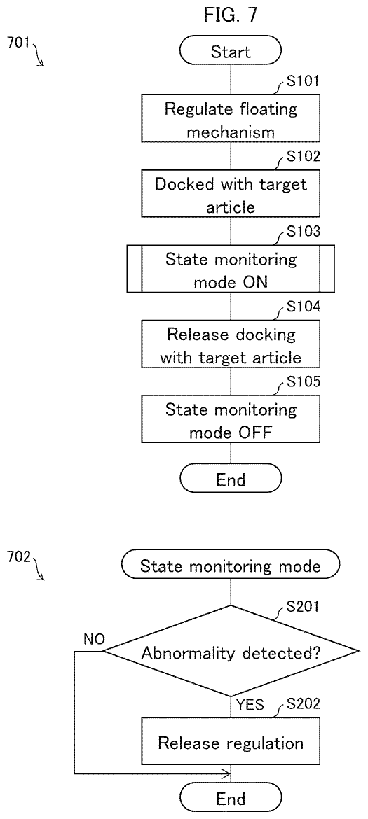

With reference to FIG. 7, the following will describe an example of a case where control by the regulation mechanism control section 20 is carried out in the present embodiment. FIG. 7 is a flowchart illustrating a flow of a regulation process by the regulation mechanism control section 20. Here, the following will describe a flow of a process carried out when an abnormality has occurred in an assembly line.

As indicated by reference numeral 701 of FIG. 7, in an assembly line, regulation by the regulation mechanism 110 is being carried out (S101). When the hand section 3 of the operation robot 1 is then connected (docked) to the target article 100 (S102), a state monitoring mode is turned on (S103). Thereafter, operation by the operation robot 1 proceeds, and when the operation is completed, the docking between the hand section 3 and the target article 100 is released (S104). The state monitoring mode is then turned off (S105). The state monitoring mode refers to a mode in which the controller 50 monitors the state of the operation robot system 10.

Reference numeral 702 of FIG. 7 indicates a flow of a process carried out when the state monitoring mode is turned on. With the state monitoring mode in an on state, when an abnormality is detected in the assembly line (YES in S201, detection step), the regulation mechanism control section 20 releases the regulation by the regulation mechanism 110 (S202, release step). This enables the floating function by the floating mechanism 4. As a result, a shift of a relative position between the arm section 2 and the hand section 3 of the operation robot 1 is permitted. Thus, even if a positional shift occurs between the target article 100 and the operation robot 1, the hand section 3 of the operation robot 1 moves together with the target article 100, and for a part of the operation robot 1 other than the hand section 3, a positional shift with the target article 100 is permitted. Therefore, it is possible to reduce a risk of occurrence of troubles, damage, or the like due to the positional shift occurring between the target article 100 and the operation robot 1 while they are connected.

The foregoing has been a description of a flow of the process carried out when an abnormality has occurred in an assembly line.

The above description has been provided on the assumption that the target article 100 is to be conveyed, but the invention in accordance with the present disclosure is not limited to this. Even in a case where the target article 100 is not conveyed, for example, a configuration may be employed in which at the time point when the operation robot 1 grips an assembly component and the like to be assembled to the target article 100, the state monitoring mode is turned on to carry out the state monitoring.

Further, the regulation mechanism control section 20 may be configured to, within an amount of a change permissible by the floating mechanism 4, carry out control for regulation up to any one of a plurality of stages of the regulation by the regulation mechanism 110 in accordance with a situation.

Further, although the foregoing has described a configuration in which the regulation is released when an abnormality is detected, timing for releasing the regulation is not limited to the case where an abnormality is detected. For example, a configuration may be employed in which in a case where a regulation release flag, which is a command to release the regulation mechanism, is detected, the regulation mechanism control section releases the regulation by the regulation mechanism.

### Example of Hand Section 3

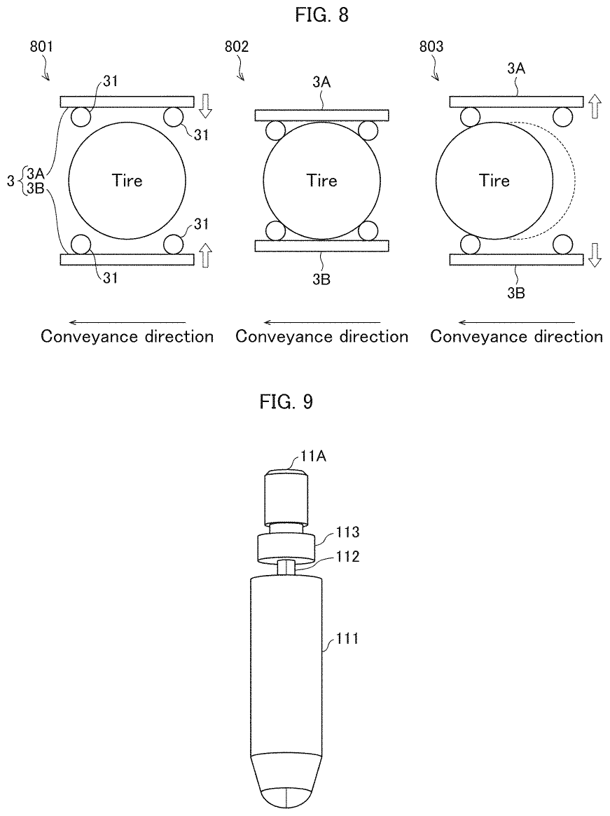

Next, with reference to FIG. 8, the following will describe one example of the hand section 3. The hand section 3 illustrated in FIG. 8 is configured to grip a tire of an automobile in a case where the target article 100 is an automobile. In the example illustrated in FIG. 8, the hand section 3 includes a hand part 3A disposed above a tire and a hand part 3B disposed below the tire (see reference numeral 801 of FIG. 8). The hand part 3A and the hand part 3B are biased in directions toward each other, and by this biasing force, the hand part 3A and the hand part 3B grip the tire (see reference numeral 802 of FIG. 8). Further, the hand part 3A and the hand part 3B are each provided with, at an end thereof in the conveyance direction, protrusions 31 that protrude toward the tire. The protrusions 31 prevent the tire gripped by the hand section 3 from being shifted in the conveyance direction.

In a case where while the hand section 3 grips the tire, a positional shift occurs between the hand section 3 and the tire for any reason, e.g., in a case where the tire is shifted further in a conveyance direction than the hand section 3, the hand part 3A and the hand part 3B pressed by the biasing force are each pushed in a direction away from the tire due to the positional shift of the tire (see reference numeral 803 of FIG. 8). This makes it possible to, while gripping the tire with use of the hand section 3, reduce troubles and damage due to a positional shift between the hand section 3 and the tire.

### Embodiment 2

The following description will discuss another embodiment of the present disclosure. For convenience, members which are identical in function to the members described in the above embodiment are given respective identical reference signs, and descriptions of those members are not repeated.

FIG. 9 illustrates an appearance of a pin part 11A in accordance with the present embodiment. As illustrated in FIG. 9, the pin part 11A includes a first body part 111, a connection part 112, and a second body part 113 in this order from the tip of the pin part 11A. That is, the connection part 112 connects the first body part 111 and the second body part 113. Further, the connection part 112 has a shorter diameter than the first body part 111 and the second body part 113, and is configured to break when the first body part 111 and the second body part 113 receive forces in different directions. In other words, the pin part 11A is configured to break when one end thereof and the other end thereof in an axial direction receive forces equal to or greater than a predetermined force in different directions. Further, when the pin part 11A breaks, the regulation by the regulation mechanism 110 is released.

The second body part 113 is connected to the first part 41 of the floating mechanism 4, and the first body part 111 is inserted into the hole 121 of the first component 12. When the connection part 112 breaks with the pin part 11A inserted into the hole 121, the regulation of the floating mechanism 4 is released. Thus, in a case where a positional shift occurs between the target article 100 and the operation robot 1 in operation, the breakage of the connection part 112 enables the function of the floating mechanism 4, and thus the positional shift between the target article 100 and the operation robot 1 is permitted. Therefore, it is possible to reduce occurrence of troubles and damage in areas other than pin part 11A.

### Software Implementation Example

The functions of the regulation mechanism control section 20 can be realized by a program for causing a computer to function as the regulation mechanism control section 20, the program causing the computer to function as the regulation mechanism control section 20.

In this case, the regulation mechanism control section 20 includes, as hardware for executing the program, a computer that includes at least one control device (e.g., a processor) and at least one storage device (e.g., a memory). The control device and the storage device execute the program, so that the functions described in the above embodiments are realized.

The program may be recorded in one or more non-transitory computer-readable recording media. The one or more recording media may or may not be included in the control device. In the latter case, the program can be supplied to the device via any wired or wireless transmission medium.

Alternatively, some or all of the functions of the regulation mechanism control section 20 can be realized by a logic circuit. For example, the present disclosure encompasses, in its scope, an integrated circuit in which a logic circuit that functions as each of the control blocks is formed. In addition, the function of each of the control blocks can be realized by, for example, a quantum computer.

Further, each of the processes described in the above embodiments can be executed by artificial intelligence (AI). In this case, the AI may be operated by the control device or may be operated by another device (for example, an edge computer and a cloud server).

Aspects of the present invention can also be expressed as follows:
An operation robot system in accordance with Aspect 1 of the present disclosure includes: an operation robot configured to carry out an operation on a target article, which is a target of the operation, while moving at a speed identical to a speed of conveyance of the target article; a hand section configured to be connected to the target article in the operation; an arm section configured to control a position of the hand section so as to connect the hand section and the target article; a floating mechanism disposed between the hand section and the arm section, connecting the hand section and the arm section, and configured to permit a change of a relative position of the hand section with respect to the arm section; a regulation mechanism configured to carry out regulation of the change of the relative position by the floating mechanism; and a regulation mechanism control section configured to, in accordance with the speed of the conveyance and whether the target article and the hand section are connected, control whether or not the regulation by the regulation mechanism is carried out.

According to the above configuration, a change of the relative position of the hand section connecting the target article and the operation robot with respect to the arm section is permitted by the floating mechanism in accordance with whether the regulation by the regulation mechanism is being carried out. Further, whether the regulation mechanism carries out regulation is controlled in accordance with the conveyance speed and whether the hand section and the target article are connected.

Thus, in a case where the target article stops while connected to the hand section of the operation robot, the regulation by the regulation mechanism is released. As a result, even when a relative position between the target article and the hand section of the operation robot is shifted, the shift of the relative position between the target article and the hand section of the operation robot is permitted within a range in which the relative position between the hand section and the arm section is permitted by the floating mechanism. This makes it possible to prevent damage to the target article or the operation robot.

An operation robot system in accordance with Aspect 2 of the present disclosure is configured, in Aspect 1, such that the floating mechanism includes a first part and a second part and is configured to permit the change of the relative position through movement of the second part with respect to the first part, and the regulation mechanism includes a pin part connected to the first part and a first component connected to the second part and provided with a hole. According to the above configuration, it is possible to achieve the regulation mechanism with use of the pin part and the hole.

An operation robot system in accordance with Aspect 3 of the present disclosure is configured, in Aspect 1 or 2, such that the regulation mechanism regulates an amount of the change of the relative position by the floating mechanism in a plurality of stages, and the regulation mechanism control section controls the plurality of stages for the regulation by the regulation mechanism in accordance with the speed of the conveyance and whether the target article and the hand section are connected. According to the above configuration, an amount of the change permitted by the floating mechanism differs in accordance with the stage of the regulation by the regulation mechanism. Thus, it is possible to carry out regulation by the regulation mechanism in accordance with a degree of the positional shift between the target article and the operation robot.

An operation robot system in accordance with Aspect 4 of the present disclosure is configured, in Aspect 2 or 3, such that the pin part has a shape varying in thickness in an axial direction. According to the above configuration, the pin part has a shape that varies in thickness in an axial direction, and thus it is possible to adjust an amount of a change to be regulated, in accordance with a degree of the insertion into the hole.

An operation robot system in accordance with Aspect 5 of the present disclosure is configured, in any one of Aspects 1 to 4, such that the floating mechanism includes a first part and a second part and is configured to permit the change of the relative position through movement of the second part with respect to the first part, the regulation mechanism includes a pin part connected to the first part and a first component connected to the second part and provided with a hole, the regulation mechanism carries out the regulation in accordance with whether the pin part is inserted into the hole, the pin part is configured to break when one end thereof and the other end thereof in an axial direction receive predetermined forces in different directions, and when the pin part breaks, the regulation by the regulation mechanism is released. In a case where the relative position between the target article and the operation robot is shifted, the relative position between the hand section and the arm section is shifted. According to the above configuration, the pin part is configured to break when one end and the other end of the pin part in an axial direction receive predetermined forces in different directions. Thus, when a relative position between the target article and the arm section is shifted, the pin part breaks. This makes it possible to prevent damage to the operation robot other than the pin part.

An operation robot system in accordance with Aspect 6 of the present disclosure is configured, in any one of Aspects 2 to 5, such that the regulation mechanism control section carries out regulations in three stages: a first regulation in which when the pin part is inserted into the hole, an outer periphery of the pin part comes into contact with an inner periphery of the hole; a second regulation in which when the pin part is inserted into the hole, the outer periphery of the pin part does not come into contact with the inner periphery of the hole; and a third regulation in which the pin part is not inserted into the hole. According to the above configuration, it is possible to carry out the regulation in three stages.

An operation robot system in accordance with Aspect 7 of the present disclosure is configured, in any one of Aspects 2 to 6, to further include a drive section configured to carry out, for at least one of the first part and the second part, an insertion operation of the pin part into the hole and a withdrawal operation of the pin part from the hole. According to the above configuration, driving of at least one of the pin part and the hole enables insertion of the pin part into the hole and withdrawal of the pin part from the hole, thus enabling regulation by the regulation mechanism.

An operation robot system in accordance with Aspect 8 of the present disclosure is configured, in any one of Aspects 2 to 7, such that a second component having less friction than that of the first component is disposed on a side surface of the hole. The second component having less friction than that of the first component is disposed on a side surface of the hole, so that it is possible to reduce friction due to contact with the pin part and absorb vibration and impact, and it is thus possible to delay deterioration of the pin part and the hole. Further, even in a case where repair is needed due to deterioration or the like, it is merely necessary to replace the second component, and thus maintenance can be carried out easily and simply.

A method for controlling an operation robot system in accordance with Aspect 9 of the present disclosure is an operation robot system controlling method including controlling, for an operation robot including a floating mechanism, regulation of a change of a relative position by the floating mechanism, the operation robot system including the operation robot configured to carry out an operation with a hand section thereof connected to a target article, which is a target of the operation, while moving at a speed identical to a speed of conveyance of the target article, the operation robot including a regulation mechanism configured to carry out regulation of the change of the relative position by the floating mechanism and a regulation mechanism control section configured to control the regulation by the regulation mechanism, the method including: a detection step of using the regulation mechanism control section to detect an abnormality in the conveyance of the target article; and a release step of using the regulation mechanism control section to release the regulation by the regulation mechanism when the abnormality is detected. According to the above configuration, when an abnormality in conveyance is detected, the regulation of the floating mechanism is released. This makes it possible to, at the time of occurrence of an abnormality, prevent damage to the operation robot due to a shift of a relative position between the target article and the operation robot.

The present disclosure is not limited to the above-described embodiments, but can be altered by a skilled person in the art within the scope of the claims. The present disclosure also encompasses, in its technical scope of the present disclosure, any embodiment derived by appropriately combining technical means disclosed in differing embodiments.

### REFERENCE SIGNS LIST

1 Operation robot
2 Arm section
3 Hand section
4 Floating mechanism
10 Operation robot system
11, 11A Pin part
12 First component
20 Regulation mechanism control section
21 Drive section
22 Cylinder
41 First part
42 Second part
50 Controller
100 Target article
110 Regulation mechanism
121 Hole

1. An operation robot system comprising:
an operation robot configured to carry out an operation on a target article, which is a target of the operation, while moving at a speed identical to a speed of conveyance of the target article;
a hand section configured to be connected to the target article in the operation;
an arm section configured to control a position of the hand section so as to connect the hand section and the target article;
a floating mechanism disposed between the hand section and the arm section, connecting the hand section and the arm section, and configured to permit a change of a relative position of the hand section with respect to the arm section;
a regulation mechanism configured to carry out regulation of the change of the relative position by the floating mechanism; and
a regulation mechanism control section configured to, in accordance with the speed of the conveyance and whether the target article and the hand section are connected, control whether or not the regulation by the regulation mechanism is carried out.

2. The operation robot system according to claim 1, wherein
the floating mechanism includes a first part and a second part and is configured to permit the change of the relative position through movement of the second part with respect to the first part, and
the regulation mechanism includes
a pin part connected to the first part and
a first component connected to the second part and provided with a hole.

3. The operation robot system according to claim 1, wherein
the regulation mechanism regulates an amount of the change of the relative position by the floating mechanism in a plurality of stages, and
the regulation mechanism control section controls the plurality of stages for the regulation by the regulation mechanism in accordance with the speed of the conveyance and whether the target article and the hand section are connected.

4. The operation robot system according to claim 2, wherein the pin part has a shape varying in thickness in an axial direction.

5. The operation robot system according to claim 1, wherein
the floating mechanism includes a first part and a second part and is configured to permit the change of the relative position through movement of the second part with respect to the first part,
the regulation mechanism includes
a pin part connected to the first part and
a first component connected to the second part and provided with a hole,
the regulation mechanism carries out the regulation in accordance with whether the pin part is inserted into the hole,
the pin part is configured to break when one end thereof and the other end thereof in an axial direction receive predetermined forces in different directions, and
when the pin part breaks, the regulation by the regulation mechanism is released.

6. The operation robot system according to claim 2, wherein
the regulation mechanism control section carries out regulations in three stages:
a first regulation in which when the pin part is inserted into the hole, an outer periphery of the pin part comes into contact with an inner periphery of the hole;
a second regulation in which when the pin part is inserted into the hole, the outer periphery of the pin part does not come into contact with the inner periphery of the hole; and
a third regulation in which the pin part is not inserted into the hole.

7. The operation robot system according to claim 2, further comprising a drive section configured to carry out, for at least one of the first part and the second part, an insertion operation of the pin part into the hole and a withdrawal operation of the pin part from the hole.

8. The operation robot system according to claim 2, wherein a second component having less friction than that of the first component is disposed on a side surface of the hole.

9. A method for controlling an operation robot system, the method including controlling, for an operation robot including a floating mechanism, regulation of a change of a relative position by the floating mechanism, the operation robot system including
the operation robot configured to carry out an operation with a hand section thereof connected to a target article, which is a target of the operation, while moving at a speed identical to a speed of conveyance of the target article, the operation robot including a regulation mechanism configured to carry out regulation of the change of the relative position by the floating mechanism and
a regulation mechanism control section configured to control the regulation by the regulation mechanism,
the method comprising:
a detection step of using the regulation mechanism control section to detect an abnormality in the conveyance of the target article; and
a release step of using the regulation mechanism control section to release the regulation by the regulation mechanism when the abnormality is detected.
